(19) United States
(12) Patent Application Publication
(10) Pub. No.: US 2024/0418961 A1
(43) Pub. Date: Dec. 19, 2024

(54) OPENING-CLOSING LAMP STRUCTURE FOR QUICKLY REPLACING LENSES

(71) Applicant: Meko Lighting Company Limited, Dongguan (CN)

(72) Inventors: HAIPING YUAN, Dongguan (CN); CHUANBING FENG, Dongguan (CN); FENG XU, Dongguan (CN); LINA HUANG, Dongguan (CN)

(21) Appl. No.: 18/208,940

(22) Filed: Jun. 13, 2023

(51) Int. Cl. G02B 7/14; F21V 17/12

(52) U.S. Cl. CPC G02B 7/14; F21V 17/12

(57) ABSTRACT

An opening-closing lamp structure for quickly replacing lenses, comprises a lamp base, on which a lamp board is fixedly arranged, and the lamp board cooperates with lens, a connecting plate is provided on the lamp base, and the connecting plate is fixedly arranged on the lamp base by screws; an opening-closing structure, comprising a cover plate, the cover plate and the connecting plate are connected by a rotating shaft structure, the rotating shaft structure comprises a fixing block, and two connecting holes are provided on the fixing block, and the rotating shaft screws are pierced in the connecting holes, and the rotating shaft screws are respectively connected with the connecting plate and the cover plate, a set of screw holes is provided on an end of the cover plate away from the rotating shaft, and a set of screw holes is provided on a corresponding position of the lamp base.

### TECHNICAL FIELD

The present application relates to the technical field of lamps, in particular to an opening-closing lamp structure for quickly replacing lenses.

### BACKGROUND

Most of the existing street lamp lenses are fixed on the lamp body by screws, but the lenses have different angles, and when customers need another angle, the lens needs to be replaced. It is labor-intensive to disassemble and install a large number of screws around the lens, or buy a whole lamp with another angle. However, it will lead to a variety of inventories at the sellers, resulting in increased inventory pressure on the sellers.

Furthermore, in terms of replacement and installation, the waterproof strip between the existing lens and the lamp body needs to be manually installed into the waterproof groove of the lens, and many screws need to be unscrewed when disassembling the lens, and these screws have the risk of falling. On the one hand, it threatens the safety of the people under the lamps. On the other hand, if the screws fall off, it may greatly increase the workload of the staff, especially on street lamps with higher positions. On the basis of the above, the positioning of the lens is also a big problem, and it is difficult for users to position and install it without the help of professionals.

To sum up, there is a need for a lamp structure that can greatly simplify lens disassembly and assembly, and avoid the inconvenience caused by the traditional structure.

### SUMMARY

The purpose of the present application is to provide a opening-closing lamp structure for quickly replacing lenses, so as to solve the problems raised in the above-mentioned background technology.

In order to achieve the above purpose, the present application provides the following technical solutions:

An opening-closing lamp structure for quickly replacing lenses, comprising:
a lamp base, configured to provide an assembly basis, a lamp board is fixedly arranged on the lamp base, and the lamp board cooperates with lens, a connecting plate is provided on the lamp base, and the connecting plate is fixedly arranged on the lamp base by screws;
an opening-closing structure, configured to cooperate with the lamp base to fix the lens, the opening-closing structure comprises a cover plate, the cover plate and the connecting plate are connected by a rotating shaft structure, the rotating shaft structure comprises a fixing block, and two connecting holes are provided on the fixing block, and the rotating shaft screws are pierced in the connecting holes, and the rotating shaft screws are respectively connected with the connecting plate and the cover plate, a set of screw holes is provided on an end of the cover plate away from the rotating shaft structure, and a set of screw holes is also provided on a corresponding position of the lamp base, so that the cover plate and the lamp base are fixedly connected by screws.

In the present application, a plurality of positioning bones are provided in a middle part of the cover plate, and a plurality of positioning grooves are formed on corresponding positions of the lens, the lamp board and the lamp base, and the positioning bone is matched with the positioning groove so as to position the lens.

In the present application, the screws pass through the screw holes on the cover plate and cooperate with a stop washer, and the stop washer is matched with an inner wall of the cover plate at the same time, so as to prevent the screw detaching from the cover plate.

In the present application, a waterproof groove is provided around a side of the lens close to the lamp board, and a waterproof groove is also provided around the lamp base near the lamp board, and a waterproof ring is inserted into the waterproof groove on the lens and the waterproof groove on the lamp base through secondary molding.

Further, the waterproof ring cooperates with the cover plate and the lamp base, and the cover plate and the lamp base are locked by the screws, thereby compressing the waterproof ring, deforming the waterproof ring, and interfering with the waterproof groove.

In the present application, the rotating shaft screw is made of stainless steel.

In the present application, the rotating shaft structure further comprises a protective cover plate, and the protective cover plate is installed in cooperation with the fixing block in a snap-fitting manner.

In the present application, one end of the lamp base is also provided with a mounting structure, and the mounting structure cooperates with an external mounting position, so that a lamp can be assembled in a specific position as a whole.

Compared with the prior art, the beneficial effects of the present application are as follows:

1. The present application connects the cover plate and the lamp base through the rotating shaft structure, so as to realize the opening and closing of the cover plate. The replacement of the lens can be completed without dismantling the entire cover plate, which greatly simplifies the replacement process. By matching the positioning bone with the positioning groove, the high-precision positioning of the lens installation can be realized, and assembly errors can be avoided, so that users can replace it by themselves. Matched with it, the whole set of lenses can be sold together at the time of sale, and consumers can replace them according to their needs;

2. Insert the waterproof ring into the waterproof groove through secondary molding, and lock the screw in the screw hole of the cover plate through the stop washer to avoid its detachment, which further simplifies the convenience of changing the lens and avoids the danger caused by the drop of the screw or the waterproof ring and the substantial increase in the workload;

3. Through the use of stainless steel shaft screws, its strength is greatly improved to avoid the failure of the entire lamp due to shaft breakage, and the use of dual shaft screws with independent shaft structures further improves product quality.

### BRIEF DESCRIPTION OF DRAWINGS

FIG. 1 is an overall structural diagram of the present application;

FIG. 2 is an overall structural diagram of another angle of the present application;

FIG. 3 is an overall structural diagram of the third angle of the present application;

FIG. 4 is an explosion diagram of the present application;

FIG. 5 is an exploded view of another angle of the present application;

FIG. 6 is a structural diagram of the second embodiment of the present application.

### REFERENCE SIGNS

100. Lamp base; 101. Lamp board; 102. Connecting plate; 200. Lens; 201. Positioning groove; 202. Waterproof groove; 203. Waterproof ring; 300. Opening-closing structure; 303. Positioning bone; 400. Rotating shaft structure; 401. Fixing block; 402. Rotating shaft screw; 403. Protective cover; 500. Mounting structure; 501. Installation sliding slot; 502. Installation screw hole.

### DETAILED DESCRIPTION

The technical solution in the embodiment of the present application will be clearly and completely described below in conjunction with the accompanying drawings in the embodiment of the present application. Apparently, the described embodiments are only some of the embodiments of the present application, not all of them. Based on the embodiments in the present application, all other embodiments obtained by persons of ordinary skill in the art without making creative efforts belong to the protection scope of the present application.

### First Embodiment

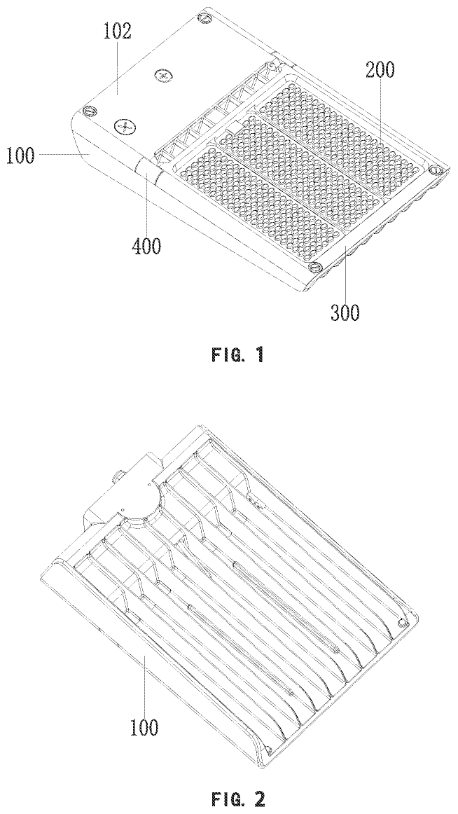

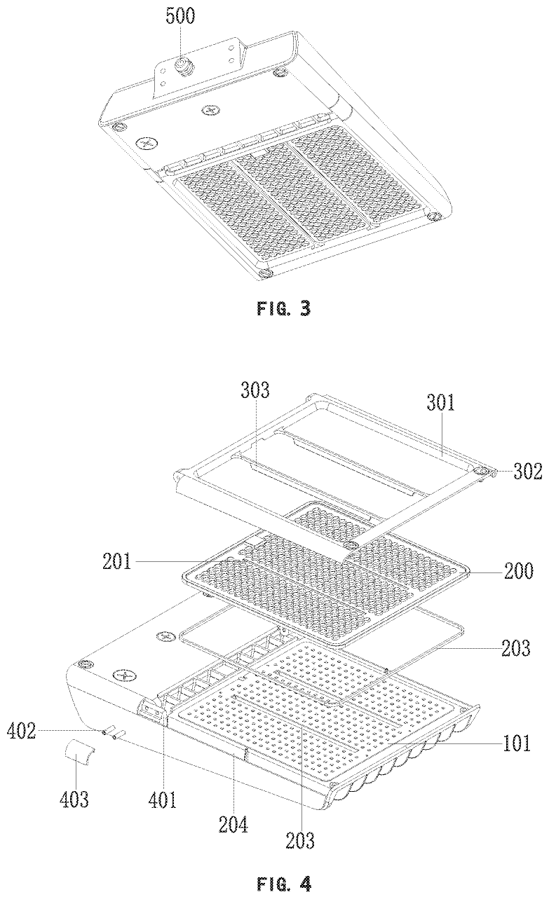

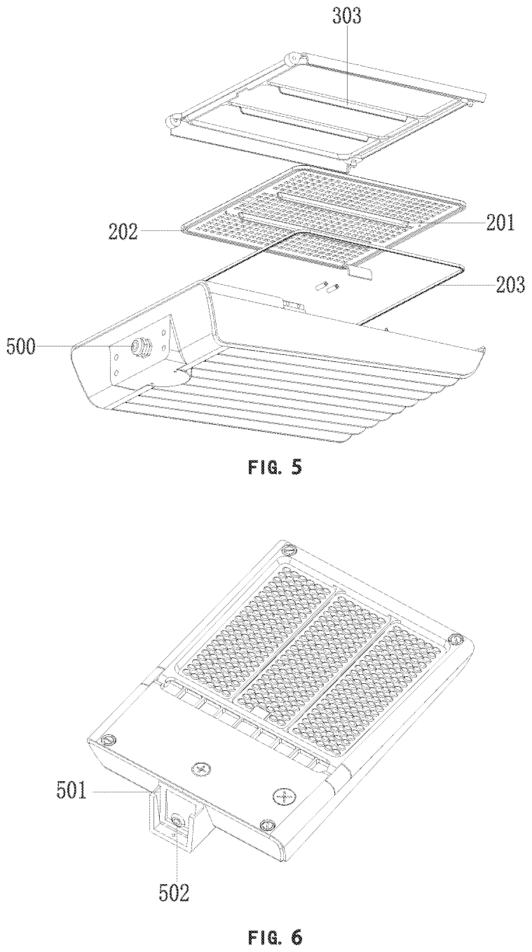

Please refer to FIGS. 1-5, an embodiment provided by the present application:

An opening-closing lamp structure for quickly replacing lenses, comprising:
a lamp base 100, configured to provide an assembly basis, a lamp board 101 is fixedly arranged on the lamp base 100, and the lamp board 101 cooperates with lens 200, a connecting plate 102 is provided on the lamp base 100, and the connecting plate 102 is fixedly arranged on the lamp base 100 by screws;
an opening-closing structure 300, configured to cooperate with the lamp base 100 to fix the lens 200, the opening-closing structure 300 comprises a cover plate 301, the cover plate 301 and the connecting plate 102 are connected by a rotating shaft structure 400, the rotating shaft structure 400 comprises a fixing block 401, and two connecting holes are provided on the fixing block 401, and the rotating shaft screws 402 are pierced in the connecting holes, and the rotating shaft screws 402 are respectively connected with the connecting plate 102 and the cover plate 301, a set of screw holes is provided on an end of the cover plate 301 away from the rotating shaft structure 400, and a set of screw holes is also provided on a corresponding position of the lamp base 100, so that the cover plate 301 and the lamp base 100 are fixedly connected by screws 302.

In this embodiment, a plurality of positioning bones 303 are provided in a middle part of the cover plate 301, and a plurality of positioning grooves 201 are formed on corresponding positions of the lens 200, the lamp board 101 and the lamp base 100, and the positioning bone 303 is matched with the positioning groove 201 so as to position the lens 200.

In this embodiment, the screws 302 pass through the screw holes on the cover plate 301 and cooperate with a stop washer, and the stop washer is matched with an inner wall of the cover plate 301 at the same time, so as to prevent the screw 302 detaching from the cover plate 301.

In this embodiment, a waterproof groove 202 is provided around a side of the lens 200 close to the lamp board 101, and a waterproof groove 202 is also provided around the lamp base 100 near the lamp board 101, and a waterproof ring 203 is inserted into the waterproof groove 202 on the lens 200 and the waterproof groove 202 on the lamp base 100 through secondary molding.

Further, the waterproof ring 203 cooperates with the cover plate 301 and the lamp base 100, and the cover plate 301 and the lamp base 101 are locked by the screws 302, thereby compressing the waterproof ring 203, deforming the waterproof ring 203, and interfering with the waterproof groove 202.

In this embodiment, the rotating shaft screw 402 is made of stainless steel.

In this embodiment, the rotating shaft structure 400 further comprises a protective cover plate 403, and the protective cover plate 403 is installed in cooperation with the fixing block 401 in a snap-fitting manner.

In this embodiment, one end of the lamp base 100 is also provided with a mounting structure 500, and the mounting structure 500 cooperates with an external mounting position, so that a lamp can be assembled in a specific position as a whole.

### Working Principle

When installation is required, the user can first match the mounting structure 500 with the external mounting position to fix and install the lamp as a whole at a specific position, and then ensure that the cover plate 300 is opened to start the installation action. First, cover the required lens 200 on the panel of the lamp board 101, align the positioning groove 201 of the lens 200 with the positioning groove 201 on the lamp board 101 and the lamp base 100, and then rotate the cover plate 300 along the rotating shaft screw 402 to make the cover plate 300 is in contact with the lamp base. At this time, the positioning bone 303 in the cover plate 300 should be aligned with and matched with the positioning groove 201 on the lens 200, so that the positioning of the lens 200 can be completed through the cover plate 300. Finally, the cover plate 300 and the lamp base 100 are locked by screws 302. During the locking process, the waterproof ring 203 is compressed and deformed, so as to closely cooperate with the waterproof groove 202 to realize the waterproof of the lamp.

When it needs to be disassembled, the user only needs to loosen the screw 302 until the cover plate 300 is separated from the lamp base 100 and remove the lens 200. The screw 302 is always kept from the cover plate 300 under the action of the stop washer, which is convenient for the user to install again after replacing the lens 200, and the operation is completed.

### Second Embodiment

Please refer to FIG. 6, an embodiment provided by the present application:

In this embodiment, the mounting structure 500 includes an installation sliding slot 501 and an installation screw hole 502.

### Working Principle

When installing the lamp as a whole, the user can first position and pre-install by matching the installation sliding slot 501 with the external mounting position, and then lock and fix it by using the screw to fit the installation screw hole 502, thereby further simplifying the installation process and reducing the difficulty of installation.

It will be apparent to those skilled in the art that the present application is not limited to the details of the exemplary embodiments described above, but that the present application can be implemented in other specific forms without departing from the spirit or essential characteristics of the present application. Therefore, the embodiments should be regarded as exemplary rather than restrictive in every respect. The protection scope of the present application is defined by the appended claims rather than the above description, and all changes that come within the meaning and range of equivalency of the claims are intended to be embraced therein. Any reference sign in a claim should not be construed as limiting the claim concerned.

What is claimed is:

1. An opening-closing lamp structure for quickly replacing lenses, comprising:
a lamp base, configured to provide an assembly basis, a lamp board is fixedly arranged on the lamp base, and the lamp board cooperates with lens, a connecting plate is provided on the lamp base, and the connecting plate is fixedly arranged on the lamp base by screws;
an opening-closing structure, configured to cooperate with the lamp base to fix the lens, the opening-closing structure comprises a cover plate, the cover plate and the connecting plate are connected by a rotating shaft structure, the rotating shaft structure comprises a fixing block, and two connecting holes are provided on the fixing block, and the rotating shaft screws are pierced in the connecting holes, and the rotating shaft screws are respectively connected with the connecting plate and the cover plate, a set of screw holes is provided on an end of the cover plate away from the rotating shaft structure, and a set of screw holes is also provided on a corresponding position of the lamp base, so that the cover plate and the lamp base are fixedly connected by screws.

2. The opening-closing lamp structure for quickly replacing lenses according to claim 1, wherein a plurality of positioning bones are provided in a middle part of the cover plate, and a plurality of positioning grooves are formed on corresponding positions of the lens, the lamp board and the lamp base, and the positioning bone is matched with the positioning groove so as to position the lens.

3. The opening-closing lamp structure for quickly replacing lenses according to claim 1, wherein the screws pass through the screw holes on the cover plate and cooperate with a stop washer, and the stop washer is matched with an inner wall of the cover plate at the same time, so as to prevent the screw detaching from the cover plate.

4. The opening-closing lamp structure for quickly replacing lenses according to claim 1, wherein a waterproof groove is provided around a side of the lens close to the lamp board, and a waterproof groove is also provided around the lamp base near the lamp board, and a waterproof ring is inserted into the waterproof groove on the lens and the waterproof groove on the lamp base through secondary molding.

5. The opening-closing lamp structure for quickly replacing lenses according to claim 4, wherein the waterproof ring cooperates with the cover plate and the lamp base, and the cover plate and the lamp base are locked by the screws, thereby compressing the waterproof ring, deforming the waterproof ring, and interfering with the waterproof groove.

6. The opening-closing lamp structure for quickly replacing lenses according to claim 1, wherein the rotating shaft screw is made of stainless steel.

7. The opening-closing lamp structure for quickly replacing lenses according to claim 1, wherein the rotating shaft structure further comprises a protective cover plate, and the protective cover plate is installed in cooperation with the fixing block in a snap-fitting manner.

8. The opening-closing lamp structure for quickly replacing lenses according to claim 1, wherein one end of the lamp base is also provided with a mounting structure, and the mounting structure cooperates with an external mounting position, so that a lamp can be assembled in a specific position as a whole.
